(19) United States
(12) Patent Application Publication
(10) Pub. No.: US 2008/0191064 A1
(43) Pub. Date: Aug. 14, 2008

(54) Seal Structure of Fuel Passage and Fuel Injection Valve Having the Seal Structure

(76) Inventors: Toshiki Sawaki, Saitama (JP); Hiroaki Nozaki, Saitama (JP)

Correspondence Address: CONNOLLY BOVE LODGE & HUTZ LLP, 1875 EYE STREET, N.W., SUITE 1100, WASHINGTON, DC, 20036, US

(21) Appl. No.: 10/591,149

(22) PCT Filed: Feb. 25, 2005
(86) PCT No.: PCT/JP05/03660

§ 371 Date: Jul. 3, 2007

(30) Foreign Application Priority Data
Mar. 4, 2004 (JP) 2004-060859

(51) Int. Cl. F02M 61/16

(52) U.S. Cl. 239/533.11

(57) ABSTRACT

In a seal structure 30 of a fuel injection valve, including an annular seal member 31 which effects sealing in order that high-pressure fuel within a pressure-introducing chamber 21 may not escape onto a low-pressure side through a gap 28 that is defined between an injector housing 2 and a valve body 6 having a valve piston 5 slidably inserted therein, and which is disposed in the pressure-introducing chamber 21; a backup ring 32 having a rigidity is arranged between the gap 28 and the seal member 31, and a recess 33 into which the seal member 31 can enter by its elasticity is provided within the pressure-introducing chamber 21, so that especially when the seal member 31 has been pushed against the backup ring 32 by the high-pressure fuel, the seal member 31 is deformed to partly enter inside the recess 33 firmly, thereby to prevent the floatation of the seal member 31.

### TECHNICAL FIELD

The present invention relates to the seal structure of a fuel channel and a fuel injection valve including the seal structure.

### BACKGROUND ART

FIG. 5 is a view for explaining the configuration of a conventional fuel injection valve. The fuel injection valve 1 is employed in order to inject and supply high-pressure fuel accumulated in a common rail 12, into the cylinder of a diesel internal combustion engine not shown. Fuel F in a fuel tank 10 is pressurized by a fuel pump 11, and the pressurized fuel is accumulated as the high-pressure fuel in the common rail 12. The fuel injection valve 1 includes an injector housing 2, a nozzle body 3, a nozzle needle 4, a valve piston 5, a valve body 6, a back-pressure control portion 7 and a connecting rod 8. The nozzle body 3 is attached to the tip portion of the injector housing 2 by a nozzle nut 9, and the connecting rod 8 is attached to the upper portion of the injector housing.

A fuel channel 13 which extends from the connecting rod 8 to the nozzle body 3 through the injector housing 2 is formed, and a fuel-accumulating chamber 14 is formed in opposition to the pressure-receiving portion 4A of the nozzle needle 4. Further, the injector housing 2 is formed with a fuel return-flow passage 15 which is branched from the fuel channel 13 near the connecting rod 8 and which communicates with a fuel low-pressure portion through the back-pressure control portion 7.

The nozzle body 3 is so configured that the tip portion of the nozzle needle 4 is seated on a seat portion 17 joined to injection ports 16, whereby the injection ports 16 are closed, and that the nozzle needle 4 is lifted from the seat portion 17, whereby the injection ports 16 are opened. Thus, the injection start and stop of the fuel are permitted. A nozzle spring 18 for urging the nozzle needle 4 in the direction of seating this nozzle needle on the seat portion 17 is disposed over the nozzle needle 4, and the valve piston 5 is slidably inserted in the slide hole 2A of the injector housing 2 and the slide hole 6A of the valve body 6.

FIG. 6 is an enlarged sectional view of the essential portions of the valve body 6 and the back-pressure control portion 7. The valve body 6 is formed with a control pressure chamber 19, and the tip portion of the valve piston 5 is confronted to the control pressure chamber 19 from the lower side thereof. The control pressure chamber 19 communicates with an introduction side orifice 20 which is formed in the valve body 6. The introduction side orifice 20 is held in communication with the fuel channel 13 through a pressure-introducing chamber 21 which is formed between the valve body 6 and the injector housing 2, and it is so configured that an introduction pressure from the common rail 12 is supplied into the control pressure chamber 19.

A seal member 22 which is made of a resin material, rubber material or copper material or any other soft material is disposed at the lower end part of the pressure-introducing chamber 21, and it cuts off the pressure-introducing chamber 21 which acts as a high pressure side and that gap 28 between the injector housing 2 and the valve body 6 which acts as a fuel low-pressure side.

The control pressure chamber 19 communicates also with an opening-and-closing orifice 23, and the opening-and-closing orifice 23 is openable and closable by the valve ball 24 of the back-pressure control portion 7. Incidentally, the pressure-receiving area of the top portion 5A of the valve piston 5 in the control pressure chamber 19 is made larger than the pressure-receiving area of the pressure-receiving portion 4A (FIG. 5) of the nozzle needle 4.

As shown in FIG. 5, the back-pressure control portion 7 includes a magnet 25, an armature 27, the valve ball 24 unitary with the armature 27, and the control pressure chamber 19. A drive signal is fed to the magnet 25, whereby the magnet 25 attracts the armature 27 against the urging force of a valve spring 26 and lifts the valve ball 24 from the opening-and-closing orifice 23, so that the pressure of the control pressure chamber 19 is permitted to be released onto the side of the fuel return-flow passage 15. Accordingly, the pressure of the control pressure chamber 19 can be controlled by operating the valve ball 24 as stated above, and the seating of the nozzle needle 4 onto the seat portion 17 and the lift thereof from the seat portion 17 can be controlled by controlling the back pressure of the nozzle needle 4 through the valve piston 5.

In the fuel injection valve 1, the high-pressure fuel from the common rail 12 acts on the pressure-receiving portion 4A of the nozzle needle 4 within the fuel-accumulating chamber 14 by flowing through the fuel channel 13 from the connecting rod 8, and it acts also on the top portion 5A of the valve piston 5 within the control pressure chamber 19 by flowing through the pressure-introducing chamber 21 as well as the introduction side orifice 20. Accordingly, when the control pressure chamber 19 is cut off from the fuel low-pressure side by the valve ball 24, the nozzle needle 4 receives the back pressure of the control pressure chamber 19 through the valve piston 5 and is seated on the seat portion 17 of the nozzle body 3 conjointly with the urging force of the nozzle spring 18, thereby to close the injection ports 16.

When the armature 27 is attracted by feeding the drive signal to the magnet 25 at a predetermined timing, and the valve ball 24 releases the opening-and-closing orifice 23, the high pressure of the control pressure chamber 19 flows back into the fuel tank 10 by passing through the fuel return-flow passage 15 via the opening-and-closing orifice 23. As a result, the high pressure having acted on the top portion 5A of the valve piston 5 in the control pressure chamber 19 is released, and the nozzle needle 4 is lifted from the seat portion 17 against the urging force of the nozzle spring 18 by the high pressure acting on the pressure-receiving portion 4A, so that the injection ports 16 are opened to inject the fuel.

When the valve ball 24 closes the opening-and-closing orifice 23 by deenergizing the magnet 25, the pressure within the control pressure chamber 19 seats the nozzle needle 4 onto the seat position thereof (the seat portion 17) through the valve piston 5, so that the injection ports 16 are closed to end the fuel injection.

Since the pressure-introducing chamber 21 is located at an entrance portion to the control pressure chamber 19 which controls a fuel injection amount and an injection pressure from the injection ports 16, the fuel pressure in the pressure-introducing chamber 21 is equivalent to the injection pressure, and a high pressure equivalent to the injection pressure acts on the seal member 22.

As shown in FIG. 6, a clearance which allows the axial slide of the valve piston 5 performing a unitary motion with the nozzle needle 4 is required between the valve piston 5 and the valve body 6. When a structure in which the valve body 6 is press-inserted into the injector housing 2 is adopted, the valve body 6 is slightly deformed inward and is apprehended to hamper the slide of the valve piston 5, and hence, the gap 28 is provided as a slight clearance also between the injector housing 2 and the valve body 6.

Since the seal structure of the conventional fuel injection valve is as stated above, the seal member is pushed and deformed toward the gap (low-pressure portion) between the injector housing and the valve body by the high pressure in the pressure-introducing chamber, and its seal function might degrade.

In order to avoid this problem, a configuration wherein a metallic backup ring is disposed on the low-pressure side (gap side) of the seal member, thereby to prevent the seal member from being pushed out onto the low-pressure side, is disclosed in JP-A-2003-28021. According to the configuration, however, there is the tendency that a pressure acts between the backup ring and the seal ring on account of the collapse or the like of the pressure-relief channel of the backup ring due to a high-pressure load, to incur a drawback in which the seal ring floats. When such floatation of the seal ring occurs, the seal performance of this seal ring might degrade to occur a hindrance in operation of a fuel injection valve.

Therefore, a contrivance for preventing the floatation by using a backup ring with a pressure-relief groove has been considered. However, when the pressure-relief groove is provided in the backup ring, it is apprehended that the seal ring will be pushed out onto the low-pressure side (gap side) with the groove acting as a channel.

An object of the present invention is to provide the seal structure of a fuel injection valve and the fuel injection valve having the seal structure as can solve the above problems in the prior art.

Another object of the invention is to provide the seal structure of a fuel injection valve as can enhance a seal function in the pressure-introducing chamber of the fuel injection valve.

Another object of the invention is to provide the seal structure of a fuel injection valve as can achieve enhancement in the durability or lifetime of a seal member.

Another object of the invention is to provide the seal structure of a fuel injection valve as does not require a component precision excessively and as is inexpensively fabricable.

Another object of the invention is to provide the seal structure of a fuel injection valve as can stabilize a seal function.

### Means for Solving the Problems

### Disclosure of the Invention

The present invention consists in disposing a backup ring which serves to prevent a seal member from being pushed out onto a low-pressure side from a gap that is formed between an injector housing and a valve body, when the annular seal member arranged in a pressure-introducing chamber is pushed down (onto the low-pressure side) by high-pressure fuel, and in providing a recess into which the seal member can enter by its elasticity, within the pressure-introducing chamber, so that especially when the seal member has been pushed against the backup ring by the high-pressure fuel, the seal member is deformed to partly enter into the recess firmly, thereby to prevent the floatation of the seal member.

A feature of the invention lies in a seal structure of a fuel channel, including an annular seal member which effects sealing in order that high-pressure fuel within a pressure-introducing chamber may not escape onto a low-pressure side through a gap that is defined between an injector housing and a valve body having a valve piston slidably inserted therein, and which is disposed in the pressure-introducing chamber; wherein a backup ring having a rigidity is arranged between the gap and the seal member, and a recess into which the seal member can enter by its elasticity is provided within the pressure-introducing chamber.

Another feature of the invention lies in a fuel injection valve including an annular seal member which effects sealing in order that high-pressure fuel within a pressure-introducing chamber may not escape onto a low-pressure side through a gap that is defined between an injector housing and a valve body having a valve piston slidably inserted therein, and which is disposed in the pressure-introducing chamber; wherein a backup ring having a rigidity is arranged between the gap and the seal member, and a recess into which the seal member can enter by its elasticity is provided within the pressure-introducing chamber.

According to the present invention, the push-out of a seal member into a gap can be prevented by a backup ring, and also the floatation of the seal member can be hindered by a recess. Any alteration is not imposed on the shape of the injector body, and any alteration is not imposed on an assembling procedure, so that a cost is hardly raised.

### BRIEF DESCRIPTION OF THE DRAWINGS

FIG. 1 is an enlarged sectional view of the essential portions of an embodiment of the present invention.

FIG. 2 is an enlarged view of a seal structure portion in FIG. 1.

FIG. 3 is an enlarged perspective view of a backup ring in FIG. 1.

FIG. 4A is a view for explaining the operation of the seal structure shown in FIG. 1.

FIG. 4B is a view for explaining the operation of the seal structure shown in FIG. 1.

FIG. 5 is a sectional view of a conventional fuel injection valve.

FIG. 6 is an enlarged sectional view of essential portions showing a valve body and a back-pressure control portion in FIG. 5, on enlarged scale.

### BEST MODE FOR CARRYING OUT THE INVENTION

In order to explain the present invention in more detail, the invention will be described in conjunction with the accompanying drawings.

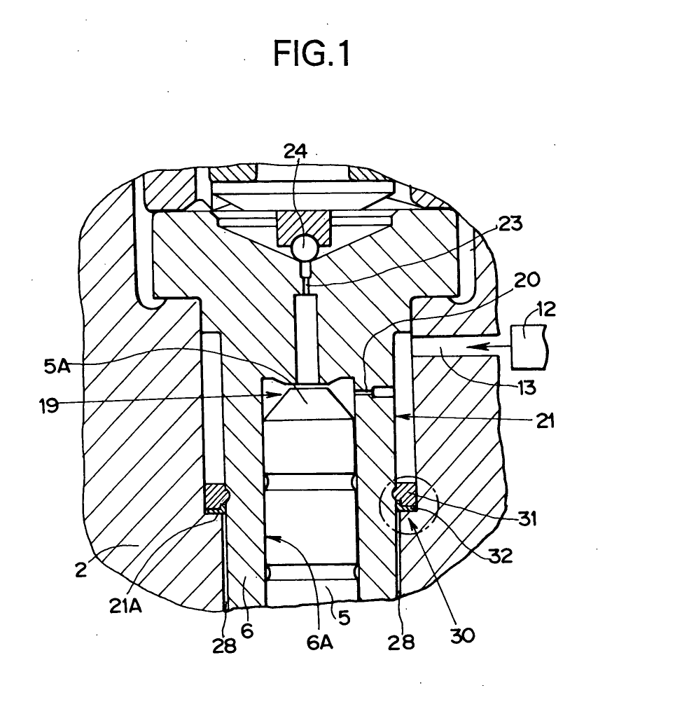

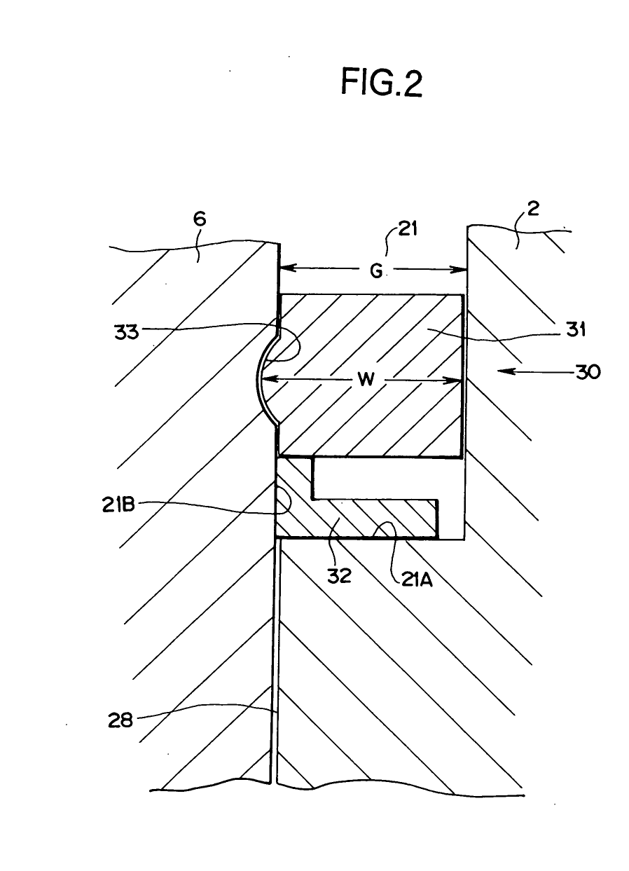

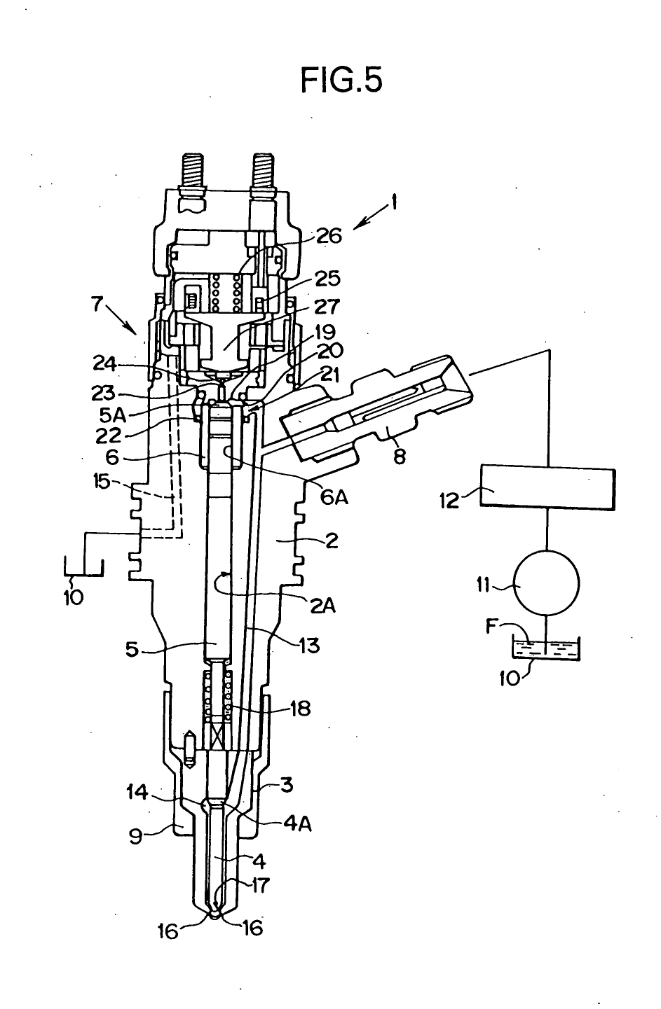

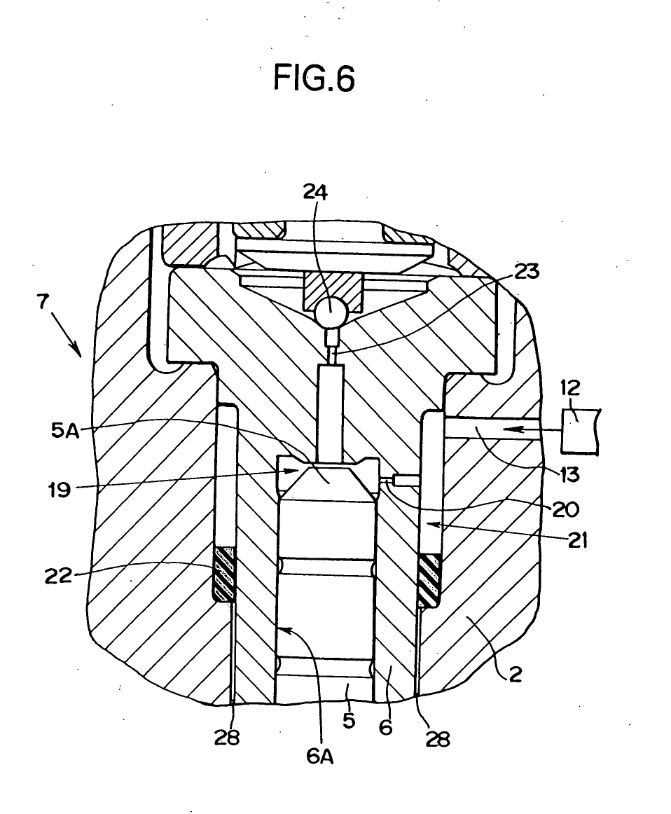

FIG. 1 is an enlarged sectional view of essential portions showing the embodiment of a fuel injection valve which includes the seal structure of a fuel channel according to the invention, while FIG. 2 is an enlarged view of a seal structure portion in FIG. 1. Portions other than the essential portions shown in FIG. 1 are the same as in the configuration of the conventional fuel injection valve shown in FIG. 5. Accordingly, in FIGS. 1 and 2, portions corresponding to the respective portions in FIGS. 5 and 6 are assigned the same numerals and signs, and the detailed description thereof shall be omitted.

Referring to FIGS. 1 and 2, a seal structure 30 is disposed in a pressure-introducing chamber 21 defining an annular space, in order to hinder high-pressure fuel within the pressure-introducing chamber 21 from escaping into a gap 28. The seal structure 30 is configured including an annular seal member 31 which is made of a resin material, or rubber material or any other soft material, and which serves to cut off (seal) the pressure-introducing chamber 21 acting as a high-pressure side, from the gap 28 between an injector housing 2 and a valve body 6 as acts as a fuel low-pressure side, and a backup ring 32 which serves to prevent the seal member 31 from being pushed out into the gap 28 by the high-pressure fuel within the pressure-introducing chamber 21.

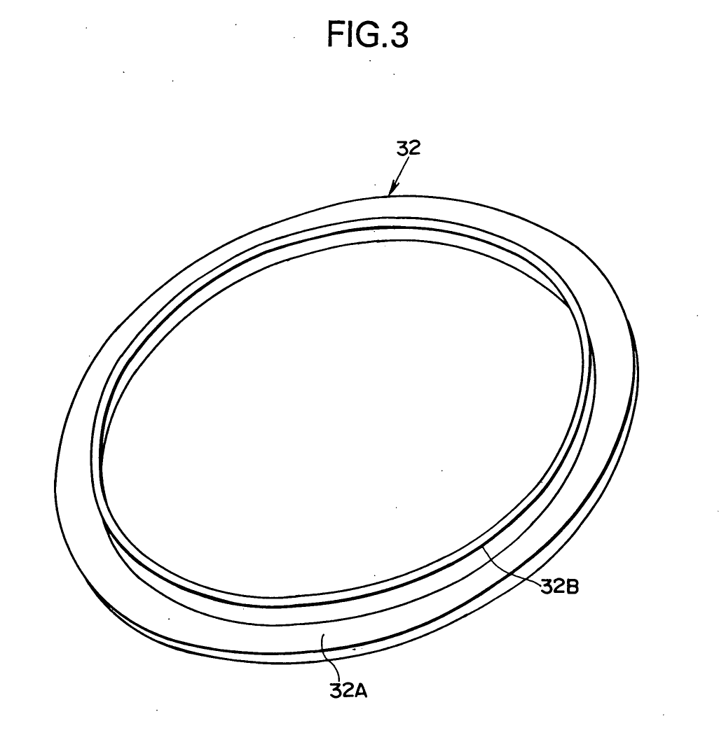

As shown in FIG. 3, the backup ring 32 is an annular member of L-shaped section configured including a seat portion 32A on which the seal member 31 is seated, and an inner peripheral wall body portion 32B which is unitarily erected at the inner peripheral end edge of the seat portion 32A. The backup ring 32 should preferably be made of a rigid material such as iron, and it should preferably be provided with no pressure-relief structure in order to prevent the seal member 31 from being pushed out. In this embodiment, the material of the backup ring 32 is iron, and no pressure-relief structure is provided. However, the shape of the backup ring 32 shown in FIG. 3 is one example, and this shape is not restrictive, but other voluntary shapes capable of preventing the push-out of the seal member 31 into the gap 28 may be employed.

As shown in detail in FIG. 2, the backup ring 32 is arranged so as to lie within the pressure-introducing chamber 21, and at a corner defined between the bottom surface 21A of the pressure-introducing chamber 21 and the inner sidewall surface 21B of this pressure-introducing chamber 21. Besides, the seal member 31 is arranged within the pressure-introducing chamber 21 so as to overlie the backup ring 32. Accordingly, in a case where the high-pressure fuel has been introduced into the pressure-introducing chamber 21, the seal member 31 is pushed toward the backup ring 32, that is, toward the bottom surface 21A, but the backup ring 32 lies within the pressure-introducing chamber 21 and closes an entrance to the gap 28. Therefore, the seal member 31 is obstructed by the backup ring 32 and is effectively prevented from being pushed out into the gap 28.

On the other hand, in order to prevent the seal member 31 from floating within the pressure-introducing chamber 21 in the case where the high-pressure fuel has been introduced into the pressure-introducing chamber 21, a recess 33 is formed at that part of the inner sidewall surface 21B of the pressure-introducing chamber 21 to which the seal member 31 opposes. In this embodiment, the recess 33 is formed in the valve body 6 as an annular groove which extends along the circumferential direction of the pressure-introducing chamber 21. Here, the seal member 31 is made of a material which is rich in elasticity, and the width W of the seal member 31 is set to be larger than the width G of the pressure-introducing chamber 21. Accordingly, in a state where the fuel injection valve has been assembled as shown in FIG. 1, part of the seal member 31 is deformed along the shape of the recess 33 and enters inside this recess 33. As a result, that part of the seal member 31 which has entered inside the recess 33 can exert a force for hindering the floatation of the seal member 31, on the seal member 31 in a case where this seal member 31 is about to float.

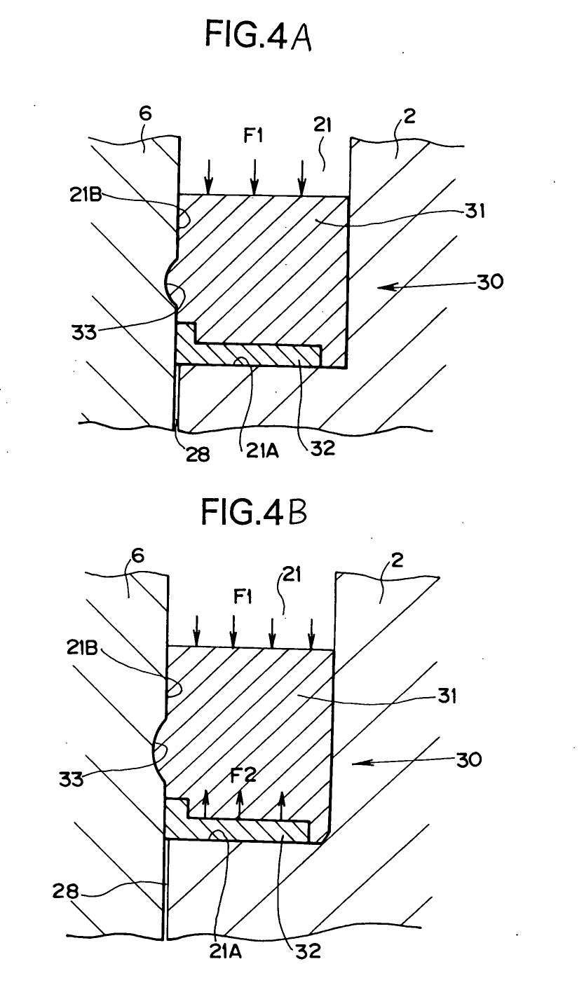

Next, the floatation preventing function of the recess 33 as based on the facts that the recess 33 is provided as stated above, and that the seal member 31 is made of the elastic material which can enter inside the recess 33, will be described with reference to FIG. 4A and FIG. 4B.

In FIG. 4A is a view showing a state where the high-pressure fuel is introduced into the pressure-introducing chamber 21, where a high pressure F1 acts on the seal member 31 and where the seal member 31 is pushed toward the bottom surface 21A of the pressure-introducing chamber 21. In this case, part of the seal member 31 is intensely pushed out into the recess 33 by the high pressure F1 and is deformed in close touch with the recess 33, so that the seal member 31 is firmly located at an illustrated position.

In FIG. 4B shows a case where a pulsation occurs in the high-pressure fuel which is introduced into the pressure-introducing chamber 21, and where, in addition to the high pressure F1, a force F2 in the direction of bringing the seal member 31 away from the backup ring 32 acts on the seal member 31. In case of F1>F2, the same result as in FIG. 4A is produced, but when the forces become F1<F2, a floating force comes to act on the seal member 31. Even in this case, however, the seal member 31 is deformed by the two forces (F1, F2) vertically acting on this seal member 31, and part of the seal member 31 is pushed out into the recess 33 to undergo a deformation along the concave shape of the recess 33. Owing to the deformation, the seal member 31 is hindered from floating. Therefore, even when the high-pressure fuel which is introduced into the pressure-introducing chamber 21 undergoes the pulsation, the seal member 31 does not float within the pressure-introducing chamber 21, and the positional deviation of the seal member 31 does not occur.

Incidentally, a durability can be sufficiently ensured by selecting the shape and size of the recess 33 and the material of the seal member 31. Besides, as understood from the above description, the seal member 31 may well be provided on the side of the injector housing 2, or such seal members may well be provided in both the injector housing 2 and the valve body 6.

Since the seal structure 30 is configured as described above, the push-out of the seal member 31 being a high-pressure seal, into the gap 28 can be effectively prevented by the backup ring 32, and simultaneously, the floatation of the seal member 31 can be reliably prevented.

Further, in the conventional seal structure configured by employing the backup ring, the invention may be applied by altering merely the backup ring, that is, the betterment of the seal structure can be attained without imposing any alteration on the shape of the injector body, etc., and no influence is exerted on an injection performance. Moreover, since the number of components is not altered, any alteration is not incurred in an assembling procedure, so that an assembling property is slightly influenced. In this manner, the points of alterations to the existing structure are small in number, and the invention therefore has the advantage that a cost involved in the alterations may be low.

### INDUSTRIAL APPLICABILITY

As described above, the seal structure of a fuel channel according to the present invention can better the reliability of a structure for preventing the fuel of the high-pressure portion of a fuel injection valve from escaping onto the side of a fuel low-pressure portion, and it serves for betterments in the fuel injection valve, etc.

1. A seal structure of a fuel channel, including an annular seal member which effects sealing in order that high-pressure fuel within a pressure-introducing chamber may not escape onto a low-pressure side through a gap that is defined between an injector housing and a valve body having a valve piston slidably inserted therein, and which is disposed in the pressure-introducing chamber, characterized in that a backup ring having a rigidity is arranged between the gap and the seal member, and that a recess into which the seal member can enter by its elasticity is provided within the pressure-introducing chamber.

2. A seal structure of a fuel channel as claimed in claim 1, wherein said recess is an annular groove which is formed in the valve body.

3. A seal structure of a fuel channel as claimed in claim 2, wherein said annular groove extends along a circumferential direction of the pressure introducing chamber.

4. A seal structure of a fuel channel as claimed in claim 1, wherein said backup ring is arranged so as to lie at a corner between a bottom surface of the pressure introducing chamber and an inner sidewall surface of the pressure introducing chamber.

5. A seal structure of a fuel channel as claimed in claim 1, wherein said backup ring is arranged so as to cover the gap on a bottom surface of the pressure introducing chamber.

6. A seal structure of a fuel channel as claimed in claim 1, wherein said backup ring is a member including a seat portion on which the seal member is seated, and an inner-peripheral wall body portion which is unitarily erected at an inner-peripheral end edge of said seat portion.

7. A fuel injection valve including an annular seal member which effects sealing in order that high-pressure fuel within a pressure-introducing chamber may not escape onto a low-pressure side through a gap that is defined between an injector housing and a valve body having a valve piston slidably inserted therein, and which is disposed in the pressure-introducing chamber, characterized in that a backup ring having a rigidity is arranged between the gap and the seal member, and that a recess into which the seal member can enter by its elasticity is provided within the pressure-introducing chamber.

8. A seal structure of a fuel channel as claimed in claim 7, wherein said recess is an annular groove which is formed in the valve body.

9. A seal structure of a fuel channel as claimed in claim 8, wherein said annular groove extends along a circumferential direction of the pressure introducing chamber.

10. A seal structure of a fuel channel as claimed in claim 7, wherein said backup ring is arranged so as to lie at a corner between a bottom surface of the pressure introducing chamber and an inner sidewall surface of the pressure introducing chamber.

11. A seal structure of a fuel channel as claimed in claim 7, wherein said backup ring is arranged so as to cover the gap on a bottom surface of the pressure introducing chamber.

12. A seal structure of a fuel channel as claimed in claim 7, wherein said backup ring is a member including a seat portion on which the seal member is seated, and an inner-peripheral wall body portion which is unitarily erected at an inner-peripheral end edge of said seat portion.
